(19) United States
(12) Patent Application Publication
(10) Pub. No.: US 2022/0147839 A1
(43) Pub. Date: May 12, 2022

(54) COMPARISONS OF KNOWLEDGE GRAPHS REPRESENTING COMPUTER SYSTEMS

(71) Applicant: Hewlett-Packard Development Company, L.P., Spring, TX (US)

(72) Inventors: Augusto Queiroz de Macedo, Porto Alegre (BR); Roberto Argenta Coutinho, Porto Alegre (BR)

(73) Assignee: Hewlett-Packard Development Company, L.P., Spring, TX (US)

(21) Appl. No.: 17/418,548

(22) PCT Filed: Jul. 15, 2019
(86) PCT No.: PCT/US2019/041870

§ 371 Date: Jun. 25, 2021

(51) Int. Cl. G06N 5/02; G06F 16/28; G06F 16/901

(52) U.S. Cl. CPC G06N 5/022; G06F 16/9024; G06F 16/287

(57) ABSTRACT

An example of a non-transitory computer-readable medium to store machine-readable instructions to be executed by a processor. The instructions may cause the processor to create a first knowledge graph to represent a computer system at a first time. The first knowledge graph may include a first set of entries to represent a first set of components of the computer system. The instructions may cause the processor to create a second knowledge graph to represent the computer system at a second time after the first time. The instructions may cause the processor to compare the second knowledge graph with the first knowledge graph and perform a corrective action based on the comparison.

### BACKGROUND

Fleets of computer systems may be managed by fleet management systems. Fleet management systems may be used to detect threats or fraud related to the computer systems. Threats or fraud may include malicious applications, such as viruses or malware, computer system components infected with such applications, unauthorized replacement or removal of computer system components, or use of storage devices to steal confidential information.

### BRIEF DESCRIPTION OF THE DRAWINGS

Various examples will be described below referring to the following figures:

FIG. 1 shows a computer system to create and compare knowledge graphs in accordance with various examples;

FIG. 2 shows a computer system to create, update, and compare knowledge graphs in accordance with various examples;

FIG. 3 shows a computer system networked to a remote device in accordance with various examples; and

FIG. 4 shows a method to create and verify knowledge graphs in accordance with various examples.

### DETAILED DESCRIPTION

A company may manage a fleet of computer systems, but the computer systems are in the possession of individual employees. The employees may be in various locations, including remote locations far from a company campus. Various safeguards, such as firewalls and being located at a secure campus may not be available to protect the computer systems from a physical breach of security or from the installation of malicious applications.

A knowledge graph may be created to track the state of computer systems. One knowledge graph may be created from an initial known state, such as when the computer systems are assembled or initially brought under company control. Later knowledge graphs may be created to track changes and modifications to the computer systems. The knowledge graphs may be updated regularly and used to identify security risks and initiate corrective actions.

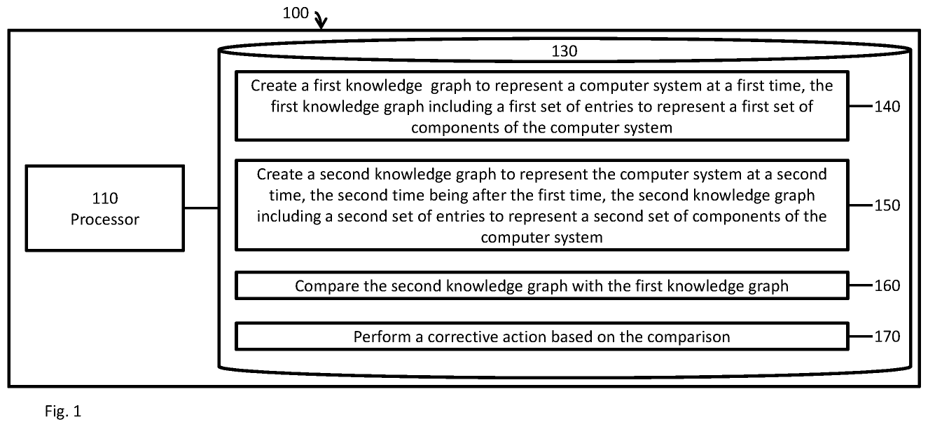

FIG. 1 shows a computer system 100 to create and compare knowledge graphs in accordance with various examples. The computer system includes a processor 110 and storage 130. The storage 130 stores machine-readable instructions 140, 150, 160, 170 for execution by the processor 110. The machine-readable instruction 140 is to create a first knowledge graph to represent a computer system at a first time, the first knowledge graph including a first set of entries to represent a first set of components of the computer system. The machine-readable instruction 150 is to create a second knowledge graph to represent the computer system at a second time, the second time being after the first time, the second knowledge graph including a second set of entries to represent a second set of components of the computer system. The machine-readable instruction 160 is to compare the second knowledge graph with the first knowledge graph The machine-readable instruction 170 is to perform a corrective action based on the comparison.

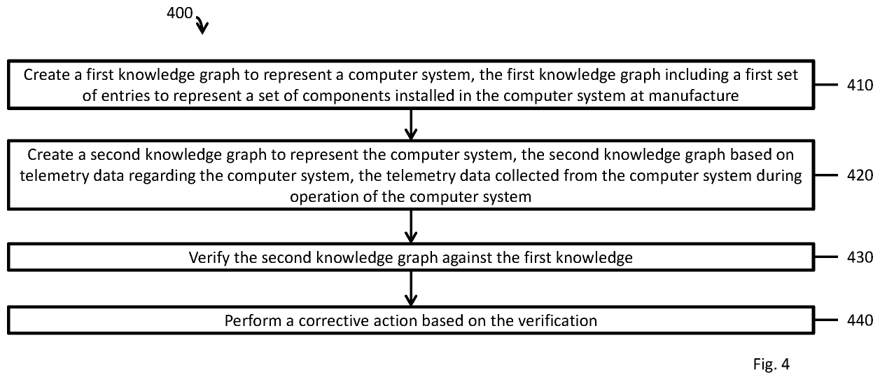

The processor 110 may be coupled to the storage 130, such as via a bus. The processor 110 may comprise a microprocessor, a microcomputer, a microcontroller, a field programmable gate array (FPGA), or discrete logic. The processor 110 may execute machine-readable instructions 140, 150, 160, 170 that implement the methods described herein, such as the method described in connection with FIG. 4. The storage 130 may include a hard drive, solid state drive (SSD), flash memory, electrically erasable programmable read-only memory (EEPROM), or random access memory (RAM).

An ontology includes a data structure to model objects and relationships between the objects. An ontology may also model attributes of the objects. An ontology may be stored in various formats, such as using extensible markup language (XML), a graph database, a resource description framework, web ontology language, or other formats.

In various examples, a computer system such as computer system 100 may be modeled in an ontology. Such an ontology may have an entry for the computer system 100 and define a relationship with the processor 110, such as a “has” relationship. The ontology may specify the computer system 100 has the processor 110, to indicate the processor 110 is installed in the computer system 100. The ontology may also specify the computer system 100 has the storage 130. The ontology may represent an attribute of the components, such as representing a unique identification number for the processor 110, or a power consumption or model number.

In various examples, the ontology may be implemented as a knowledge graph. A knowledge graph includes a representation of nodes and edges between the nodes. The nodes may represent components of the computer system 100. One node may represent the computer system 100. One node may represent the processor 110. One node may represent the storage 130. An edge may connect the computer system 100 with the processor 110. That edge may represent the “has” relationship, that the computer system 100 has the processor 110. The edge representation may include directional information to indicate the computer system 100 has the processor 110, not vice-versa. Nodes representing components may be categorized as component nodes. Nodes may also be used to represent attributes and be categorized as attribute nodes. The processor 110 may be coupled via an edge to an attribute node that includes a model number of the processor 110. The processor 110 may be coupled via another edge to an attribute node that includes a unique identification of the processor 110. In various examples, properties of the edges may indicate the kinds of nodes being connected. A “has” edge may indicate that both nodes are components. An “attribute” edge may be used to indicate one of the nodes is an attribute of the other node. Numerous variations on the kinds of nodes and edges may be used to implement the knowledge graph. The knowledge graph may allow for searching of the ontology to determine or retrieve information regarding the subject being modeled.

In various examples, the computer system 100 may be used to model computer systems that are part of a fleet of computer systems. The computer system 100 may be part of a server or centralized system to track the various computer systems in the fleet.

The knowledge graph creation instructions 140, 150 may be executed by the processor 110 to create a knowledge graph representing computer systems. The knowledge graph creation instructions 140, 150 may be used to create knowledge graphs of computer systems, such as when the computer systems are introduced to the fleet of computer systems or when the computer systems are being manufactured. The computer systems in the fleet of computer systems may be represented by knowledge graphs. The fleet of computer systems may be represented by a knowledge graph. The knowledge graph creation instructions 140,150 may be used to create knowledge graphs based on telemetry data gathered from the computer systems. The computer system 100 may store data regarding the knowledge graph of computer systems as they are when initially manufactured and then create a later knowledge graph of the computer systems after they have been in use.

The knowledge graph comparison instructions 160 may be executed by the processor 110 to compare knowledge graphs of computer systems. A knowledge graph of a computer system as it was originally manufactured may be compared to a knowledge graph created based on telemetry data after some amount of use. The comparison may identify changes to the computer system since its original manufacture. For example, the knowledge graph comparison may indicate the replacement of a component, such as a storage 130. The comparison may generate information about the difference in the original storage and the replacement storage, such as model numbers, unique identification numbers, storage capacity, what happened to the original storage, and a list of computer systems that previously included the replacement storage.

The corrective action instructions 170 may be executed by the processor 110 to take corrective action based on the comparison of knowledge graphs. The corrective actions may be wide-ranging, from displaying messages to a user of the computer system 100 or a user of the computer system for which the knowledge graphs were compared, creating a log or report of changes to the computer systems in the fleet of computer systems, disabling network access to a computer system in the fleet of computer systems, disabling a login to a computer system in the fleet of computer systems, installing or uninstalling applications on a computer system in the fleet of computer systems, or scheduling a technician to service a computer system in the fleet of computer systems.

In various examples, the knowledge graph creation instructions 140, 150 may create a first knowledge graph representing a computer system at a first point in time and a second knowledge graph representing the computer system at a second point in time. The first point in time may be when the computer system is manufactured or when the computer system is added to the fleet of computer systems. The second point in time may be after the computer system has been in use and may correspond to a collection of telemetry data about the computer system. The knowledge graph comparison instructions 160 may compare the two knowledge graphs to determine differences in the computer system at the two points in time. The comparison may determine that an application was installed on the computer system or that a component of the computer system was replaced. The corrective action instructions 170 may determine a corrective action to take, based on the comparison. If an application was installed on the computer system, the corrective action instructions 170 may determine the application is a suspected virus or malware and cause it to be uninstalled and a virus scan or malware scan to be performed on the computer system. Or the corrective action instructions 170 may determine that the application is one of a set of authorized applications for the computer and determine no corrective action should be taken. If a storage device was added to the computer system, the corrective action instructions 170 may determine it is an authorized storage device and no action is to be taken, or the corrective action instructions 170 may determine the storage device was potentially being used to steal confidential information. To correct for the potential theft of confidential information, a corrective action to alert security personnel at a corporate campus location may be performed, a network connection of the computer system may be deactivated, or the computer system may be disabled.

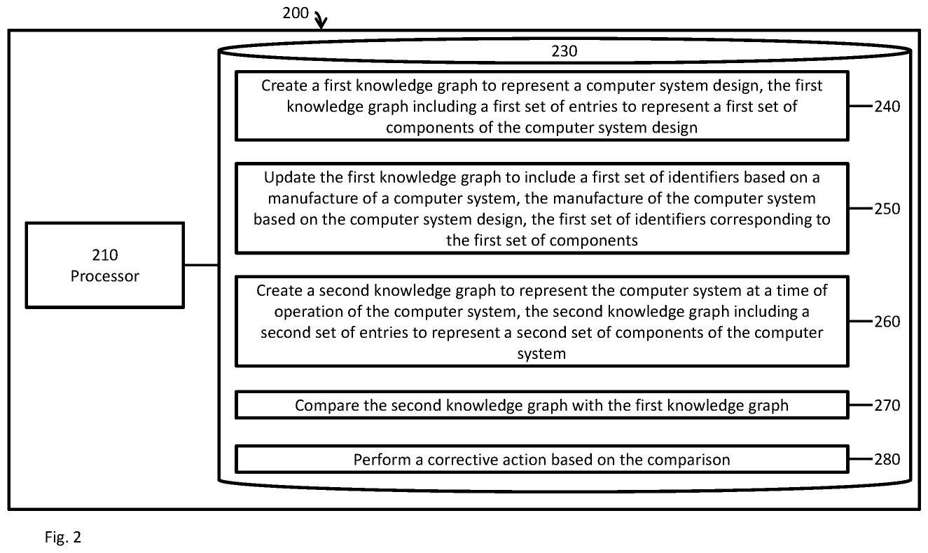

FIG. 2 shows a computer system 200 to create, update, and compare knowledge graphs in accordance with various examples. The computer system 200 includes a processor 210 and storage 230. The storage 230 stores machine-readable instructions 240, 250, 260, 270, 280. The instruction 240 is to cause the processor 210 to create a first knowledge graph to represent a computer system design, the first knowledge graph including a first set of entries to represent a first set of components of the computer system design. The instruction 250 is to cause the processor 210 to update the first knowledge graph to include a first set of identifiers based on a manufacture of a computer system, the manufacture of the computer system based on the computer system design, the first set of identifiers corresponding to the first set of components. The instruction 260 is to cause the processor 210 to create a second knowledge graph to represent the computer system at a time of operation of the computer system, the second knowledge graph including a second set of entries to represent a second set of components of the computer system. The instruction 270 is to cause the processor 210 to compare the second knowledge graph with the first knowledge graph. The instruction 280 is to cause the processor 210 to perform a corrective action based on the comparison.

In various examples, the computer system 200 may receive data regarding the manufacture of a device. A knowledge graph may be used to represent a design for the device, such as listing components to be used and including information about model identifiers for the specific components to be used. When specific components are selected and installed in the device, the knowledge graph may be updated. Updating the knowledge graph may include adding unique identifiers to identify the specific components used. Updating the knowledge graph may include updating identifiers that are specific to a regional or language-based build of the device, such as including a different power cord for a device to be used in the United States of America versus one to be used in Germany. Updating the knowledge graph may include updating information regarding applications installed on the device, including names, versions, or settings of the applications.

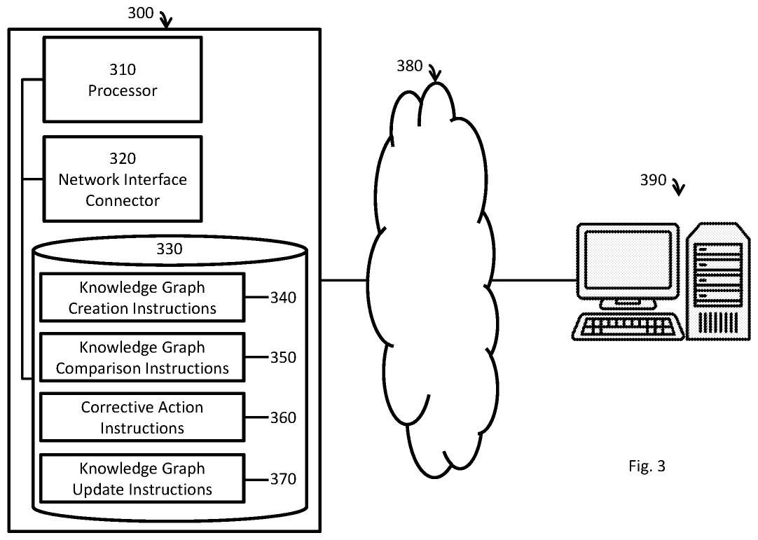

FIG. 3 shows a computer system 300 networked to a remote device 390 in accordance with various examples. The computer system 300 includes a processor 310, a network interface connector 320, and storage 330. The processor 310, network interface connector 320, and storage 330 may be coupled together, such as via a bus. The network interface connector 320 may couple the computer system 300 to a fleet of electronic devices that includes remote device 390. The coupling may be via a wired connection, such as an Ethernet cable or Universal Serial Bus (USB) or via a wireless connection, such as WiFi. The connection may be via a network 380, which may include the Internet. The fleet of electronic devices may include remote devices 390 such as tablets, laptop computer systems, desktop computer systems, servers, and cell phones. Storage 330 includes knowledge graph creation instructions 340, knowledge graph comparison instructions 350, corrective action instructions 360, and knowledge graph update instructions 370.

The knowledge graph update instructions 370 may be executed by the processor 310 to update a knowledge graph representing the remote device 390. The computer system 300 may store a knowledge graph representing the remote device 390, such as in storage 330.

In various examples, the computer system 300 may receive telemetry data regarding the remote device 390. The telemetry data may indicate the components of the remote device and applications installed on the remote device. The telemetry data may include changes to the remote device since a prior collection of telemetry data. The knowledge graph update instructions 370 may use the telemetry data to modify the stored knowledge graph representing the remote device 390. The precise modifications may vary based on the way the knowledge graph is implemented. For example, if the knowledge graph comprises nodes signifying components and attributes of components and edges indicating relationships between the components and attributes, the knowledge graph update instructions 370 may add additional nodes and edges, remove nodes and edges, and update attributes.

In various examples, the telemetry data may be collected at a boot time of the remote device 390. Or the data may be collected when the remote device 390 is idle or at a regularly scheduled time, such as once per day or month.

In various examples, the processor 310 may be external to the remote device 390. The processor 310 may be part of a computer system 300 to provide fleet management for a set of computer systems that includes the remote device 390. The fleet management may also include management of the computer system 300 itself.

In various examples, the knowledge graphs may include model identifiers for components in the remote device 390. The knowledge graphs may include unique identifiers to identify specific components and distinguish between different components with the same model identifier. This may allow the knowledge graph comparison instructions 350 to determine when a component of the remote device 390 has been replaced. This may indicate a component broke and was replaced as part of a repair, or the component may have been stolen and replaced with a faulty component.

In various examples, the ontologies may keep track of the replacement of components of the computer systems, including a history of the components previously used in a computer system. Using the unique identifiers, it may be possible to determine that a component in the remote device 390 was previously used in another computer system. This may be useful to track computer systems that may have been compromised by a component that has been used across multiple computer systems. A memory stick may be used with multiple computer systems to transfer data. The memory stick may become infected with a virus at some point. Tracking the various computer systems that have been coupled to the memory stick may assist with removing the virus from the fleet of computer systems or identifying where the virus originated.

FIG. 4 shows a method 400 to create and verify knowledge graphs in accordance with various examples. The method 400 includes creating a first knowledge graph to represent a computer system, the first knowledge graph including a first set of entries to represent a set of components installed in the computer system at manufacture (block 410). The method 400 includes creating a second knowledge graph to represent the computer system, the second knowledge graph based on telemetry data regarding the computer system, the telemetry data collected from the computer system during operation of the computer system (block 420). The method 400 includes verifying the second knowledge graph against the first knowledge graph (block 430). The method includes performing a corrective action based on the verification (block 440).

In various examples, the ontologies may include information regarding a time of removal or addition of a component. Information regarding a reason for the modification may also be included in the ontology. Analysis of the ontologies may indicate trends. A certain computer system configuration may experience a component failure at predictable intervals. This may allow corrective actions such as predictive maintenance of the computer systems or keeping replacement components in stock and ready to replace failed components. Certain computer configurations may experience a higher than expected number of component failures compared with other computer system configurations. This may allow corrective actions such as detection and correction of design issues, such as specifying a larger power supply or a different fan model for future versions of that computer system configuration. The ontology may be searchable for various events. The events may include the addition or removal of components or applications. The events may also include when the computer system is booted, shut down, physically moved to a different location or reassigned, connected to a network, or other events. Searching on the events may allow performance of corrective actions on computers, if an issue is discovered that is related to an event, such as connecting to a compromised network, such as a wireless connection of a particular coffee shop.

In various examples, the ontology may be presented to a user as a visualization, such as in a visual format of a knowledge graph. Nodes and edges may be used to visualize the components of the computer system and attributes and relationships of the components. This may be done even if the ontology is implemented in a format other than a node and edge format. The visualization may be in connection with search functionality to show connections between computer systems which have experienced comparable events or comparable chains of events. For example, a search may be performed on sudden shutdown of computers due to power outages, followed by a component replacement within a certain amount of time. This may indicate various issues, from electrical issues with a certain building, issues with a model of surge protectors being used with the devices, or a defect in the design of a computer system or component that makes them susceptible to power surges or power outages. Presenting a visualization of the computer systems or searches on the ontologies may assist a technician or systems administrator to recognize patterns in the data and diagnose issues, thus leading to appropriate corrective actions.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium to store machine-readable instructions that, when executed by a processor, cause the processor to:
create a first knowledge graph to represent a computer system at a first time, the first knowledge graph including a first set of entries to represent a first set of components of the computer system;
create a second knowledge graph to represent the computer system at a second time, the second time being after the first time, the second knowledge graph including a second set of entries to represent a second set of components of the computer system;
compare the second knowledge graph with the first knowledge graph; and
perform a corrective action based on the comparison.

2. The computer-readable medium of claim 1, wherein the first time includes a time of manufacture of the computer system, and the second time includes a boot up of the computer system.

3. The computer-readable medium of claim 1, wherein to perform the corrective action includes to cause the processor to display a message on a screen, the message based on the comparison.

4. The computer-readable medium of claim 1, wherein the processor is external to the computer system.

5. The computer-readable medium of claim 1, wherein the first knowledge graph includes a unique identifier corresponding to a component in the first set of components.

6. A non-transitory computer-readable medium to store machine-readable instructions that, when executed by a processor, cause the processor to:
create a first knowledge graph to represent a computer system design, the first knowledge graph including a first set of entries to represent a first set of components of the computer system design;
update the first knowledge graph to include a first set of identifiers based on a manufacture of a computer system, the manufacture of the computer system based on the computer system design, the first set of identifiers corresponding to the first set of components;
create a second knowledge graph to represent the computer system at a time of operation of the computer system, the second knowledge graph including a second set of entries to represent a second set of components of the computer system;
compare the second knowledge graph with the first knowledge graph; and
perform a corrective action based on the comparison.

7. The computer-readable medium of claim 6, wherein the first set of components includes a component, and the first set of identifiers includes a product identifier corresponding to the component and includes a unique identifier corresponding to the component.

8. The computer-readable medium of claim 6, where the machine-readable instructions, when executed by a processor, cause the processor to:
detect an addition of a component to the computer system, the component corresponding to a unique identifier;
update the second knowledge graph based on the detection, the updated second knowledge graph including an entry corresponding to the component, the second knowledge graph including the unique identifier; and
identify a third knowledge graph based on the unique identifier, the third knowledge graph corresponding to a second computer system.

9. The computer-readable medium of claim 6, wherein the first knowledge graph includes a third set of entries to represent applications to be installed as part of the computer system design, the second knowledge graph includes a fourth set of entries to represent applications installed on the computer system at the time of operation, and the comparison includes a comparison of the third set of entries with the fourth set of entries.

10. The computer-readable medium of claim 6, where the machine-readable instructions, when executed by a processor, cause the processor to update the second knowledge graph based on a change to the computer system.

11. A method comprising:
creating a first knowledge graph to represent a computer system, the first knowledge graph including a first set of entries to represent a set of components installed in the computer system at manufacture;
creating a second knowledge graph to represent the computer system, the second knowledge graph based on telemetry data regarding the computer system, the telemetry data collected from the computer system during operation of the computer system;
verifying the second knowledge graph against the first knowledge graph; and
performing a corrective action based on the verification.

12. The method of claim 11, the performing a corrective action including disabling a network interface of the computer system.

13. The method of claim 11, wherein the second knowledge graph includes an entry corresponding to a component removed from the computer system, the second knowledge graph indicating a time of the removal.

14. The method of claim 11, comprising searching the second knowledge graph for an event of the computer system, wherein the second knowledge graph includes an entry corresponding to the event.

15. The method of claim 11, comprising presenting a visualization of the knowledge graph.
